(19) United States
(12) Patent Application Publication
(10) Pub. No.: US 2025/0271341 A1
(43) Pub. Date: Aug. 28, 2025

(54) LOCAL PRESSURE TESTING JIG AND LOCAL PRESSURE TESTING METHOD

(71) Applicant: MITSUBISHI HEAVY INDUSTRIES COMPRESSOR CORPORATION, Hiroshima (JP)

(72) Inventors: Kohei Ogawa, Hiroshima (JP); Hiroaki Oka, Hiroshima (JP); Ai Ikeno, Hiroshima (JP); Shuhei Kawagoe, Hiroshima (JP); Takaaki Matsumoto, Hiroshima (JP); Takanori Matsueda, Hiroshima (JP); Reiko Yamada, Hiroshima (JP)

(73) Assignee: MITSUBISHI HEAVY INDUSTRIES COMPRESSOR CORPORATION, Hiroshima (JP)

(21) Appl. No.: 19/046,203

(22) Filed: Feb. 5, 2025

(30) Foreign Application Priority Data
Feb. 22, 2024 (JP) 2024-025282

(51) Int. Cl. G01N 3/12

(52) U.S. Cl. CPC G01N 3/12

(57) ABSTRACT

A local pressure testing jig includes: a supply pipe capable of supplying a liquid; a discharge pipe capable of discharging the liquid; a supply valve capable of adjusting a supply amount of the liquid; a discharge valve capable of adjusting a discharge amount of the liquid; an insertion pipe capable of being inserted into a through-hole and a casing hole; a detachable retaining portion detachably fixed to the additional member in a state in which the through-hole is closed; a closing portion closing the casing hole at a leading end of the insertion pipe; a sealing portion sealing between the closing portion and the casing hole; and a pressure measurement portion capable of measuring an internal pressure. The insertion pipe is formed to have a smaller diameter than the through-hole, and includes a supply hole, opening in the through-hole and capable of communicating with a space between the through-hole and the insertion pipe.

### CROSS-REFERENCE TO RELATED APPLICATIONS

This application claims the benefit of priority to Japanese Patent Application Number 2024-025282 filed on Feb. 22, 2024. The entire contents of the above-identified application are hereby incorporated by reference.

### TECHNICAL FIELD

The present disclosure relates to a local pressure testing jig and a local pressure testing method.

### RELATED ART

A compressor is known as a device for compressing gas to generate high-pressure gas. The compressor includes a rotor rotating about an axis, an impeller provided on an outside surface of the rotor, and a casing forming a flow path by covering the rotor and the impeller from an outer circumferential side. When the impeller rotates integrally with the rotor, the gas flowing through the flow path is compressed. The compressed gas is in a state in which the temperature and the pressure are increased as compared with those before compression.

Here, depending on the type of gas to be flowed, a compound contained in the gas may be polymerized inside the compressor as the temperature of the gas increases, so that a polymer called fouling is formed. When the fouling adheres to a wall surface forming the flow path, the efficiency of the compressor may be decreased. In addition, when the fouling adheres to the rotor, imbalance of the rotor may be caused, resulting in vibrations.

As a technique for removing fouling in a compressor, for example, JP 2013-177905 A discloses a cleaning fluid spray device that supplies a cleaning fluid by inserting a nozzle into a flow path in a casing.

### SUMMARY

Incidentally, when cleaning is performed using such a cleaning device, a nozzle is inserted into a casing via a cylindrical pipe including a flange fixed near the middle of the casing. There may be a case in which such a pipe is added afterward to an already formed casing. In that case, the cylindrical pipe is fixed to the outside surface of the casing by welding.

In a pressure vessel such as a casing of a compressor, it is necessary to perform a pressure test on a welded portion connecting an additional member such as a connection pipe and the existing casing. However, when the additional member is small relative to the large casing such as a compressor, performing the pressure test on the entire casing is very wasteful in terms of cost and workload. Therefore, it is desired to efficiently perform the pressure test on the welded portion between the additional member and the casing.

The present disclosure has been made to solve the above-described problem, and an object of the present disclosure is to provide a local pressure testing jig and a local pressure testing method capable of efficiently performing a pressure test on a welded portion between an additional member and a casing.

In order to solve the above described problem, a local pressure testing jig according to the present disclosure is a local pressure testing jig used for performing a local pressure test on a welded portion of a casing of a rotary machine, the local pressure test being performed by supplying liquid to an additional member having a tubular shape that is fixed to the casing by the welded portion in a state in which a through-hole inside the additional member and a casing hole formed in the casing communicate with each other. The local pressure testing jig includes: a supply pipe capable of supplying the liquid to the through-hole; a discharge pipe capable of discharging the liquid from the through-hole; a supply valve disposed at the supply pipe, the supply valve being capable of adjusting a supply amount of the liquid from the supply pipe to the through-hole; a discharge valve disposed at the discharge pipe, the discharge valve being capable of adjusting a discharge amount of the liquid from the through-hole to the discharge pipe; an insertion pipe connected to the supply pipe and the discharge pipe, the insertion pipe being capable of being inserted into the through-hole and the casing hole; a detachable retaining portion detachably fixed to the additional member in a state in which the through-hole is closed, the detachable retaining portion being capable of retaining the insertion pipe with respect to the additional member; a closing portion disposed at a leading end of the insertion pipe, the closing member closing the casing hole; a sealing portion disposed at the closing portion, the sealing portion sealing between the closing portion and the casing hole; and a pressure measurement portion capable of measuring a pressure inside the supply pipe, the discharge pipe, or the insertion pipe. The insertion pipe is formed to have a smaller diameter than the through-hole and includes a supply hole, opening in the through-hole and capable of communicating with a space between the through-hole and the insertion pipe.

A local pressure testing method according to the present disclosure is a local pressure testing method using the above-described local pressure testing jig and includes: attaching the local pressure testing jig to the additional member by fixing the detachable retaining portion to the additional member; supplying the liquid from the supply pipe by opening the supply valve and the discharge valve; closing the discharge valve after the through-hole is filled with the liquid; determining whether a pressure measured by the pressure measurement portion exceeds a test pressure determined in advance after the discharge valve is closed; closing the supply valve when it is determined that the pressure measured by the pressure measurement portion exceeds the test pressure; performing a hydraulic test on the welded portion after the supply valve is closed; and opening the supply valve and the discharge valve after the hydraulic test is performed.

According to the local pressure testing jig and the local pressure testing method of the present disclosure, the pressure test can be efficiently performed on the welded portion between the additional member and the casing.

### BRIEF DESCRIPTION OF DRAWINGS

The disclosure will be described with reference to the accompanying drawings, wherein like numbers reference like elements.

FIG. 1 is a schematic diagram illustrating a compressor subjected to a pressure test according to the present embodiment.

FIG. 2 is an enlarged view of a main portion of an intermediate flange according to the present embodiment.

FIG. 3 is a flowchart illustrating a local pressure testing method according to the present embodiment.

FIG. 4 is a schematic diagram illustrating a local pressure testing jig according to the present embodiment.

FIG. 5 is a schematic diagram illustrating a state in which the local pressure testing jig according to the present embodiment is attached to the intermediate flange.

### DESCRIPTION OF EMBODIMENTS

Hereinafter, embodiments for implementing a local pressure testing jig and a local pressure testing method according to the present disclosure will be described with reference to the accompanying drawings. However, the present disclosure is not limited only to these embodiments.

### Configuration of Rotary Machine

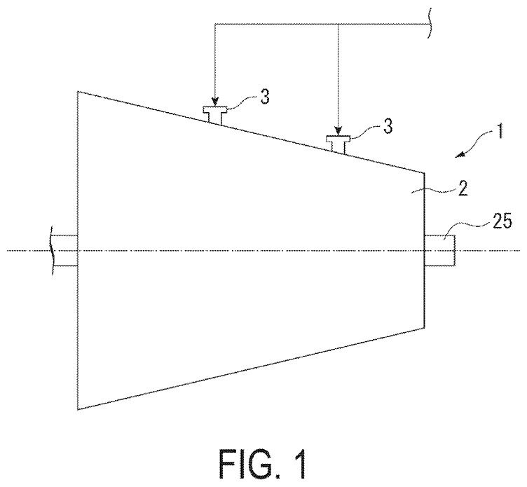

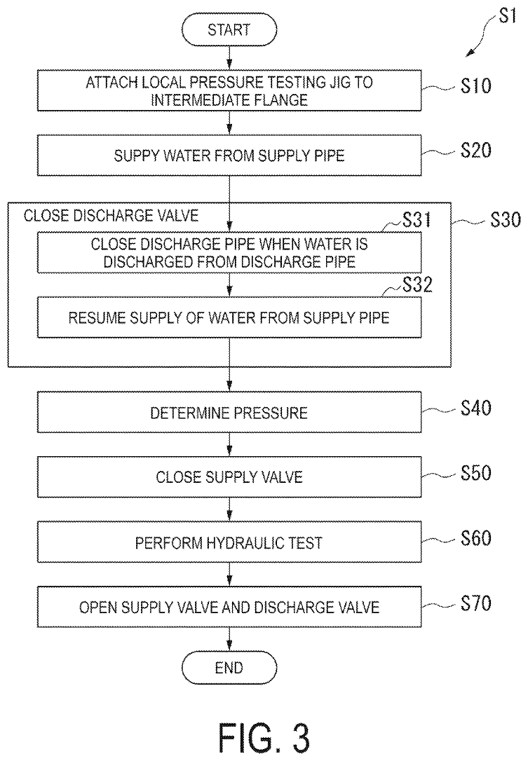

As illustrated in FIG. 1, in the present embodiment, a rotary machine to which an additional member to be subjected to a local pressure testing method S1 (see FIG. 3) is fixed is, for example, a centrifugal compressor 1. The centrifugal compressor 1 can compress supplied gas. The centrifugal compressor 1 can compress gas containing an organic chemical substance such as ethylene or propylene, or air as a working fluid. The centrifugal compressor 1 is a single-shaft multi-stage centrifugal compressor including a plurality of impellers (not illustrated). The centrifugal compressor 1 includes a casing 2 and an intermediate flange 3, the casing accommodating therein a rotor 25 including the impellers.

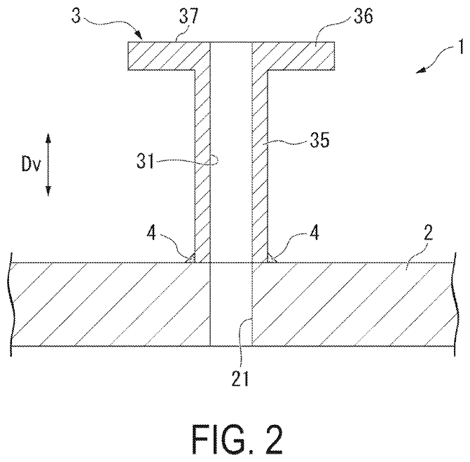

The gas is compressed in a flow path formed inside the casing 2. The casing 2 is an outer shell of the centrifugal compressor 1 and is a compression container. As illustrated in FIG. 2, the casing 2 is formed with a casing hole 21 communicating with the flow path inside the casing 2. The casing hole 21 communicates between the outside of the casing 2 and the flow path inside of the casing 2. The casing hole 21 extends straight in a vertical direction Dv.

The intermediate flange 3 is an additional member which is made in a separate process from the casing 2 and fixed to the casing 2 afterward. A plurality of intermediate flanges 3 are disposed at one casing 2 (see FIG. 1). For example, the intermediate flange 3 is used as a supply port for supplying oil which is cleaning oil and water which is cleaning water (cooling water) to the flow path inside the casing 2 in operation when cleaning of the flow path is performed. A borescope (not illustrated) or an injection device (not illustrated) may be attachable to and detachable from the intermediate flange 3. The intermediate flange 3 is formed in a tubular shape. As illustrated in FIG. 2, the intermediate flange 3 is formed therein with a through-hole 31. The through-hole 31 is formed to have the same diameter as the casing hole 21. The intermediate flange 3 of the present embodiment includes a tube main body 35 having a cylindrical shape and a flange portion 36 having an annular shape located at the upper end of the tube main body 35.

The intermediate flange 3 is fixed to the casing 2 by welding. The intermediate flange 3 is fixed to the casing 2 by a welded portion 4 in a state in which the through-hole 31 inside the intermediate flange 3 and the casing hole 21 communicate with each other. The lower end of the intermediate flange 3 in the vertical direction Dv is welded to the outside surface of the casing 2.

### Configuration of Local Pressure Testing Method

The local pressure testing method S1 (see FIG. 3) is a method for confirming whether the pressure resistance state of the welded portion 4 satisfies a criterion by supplying a liquid to the intermediate flange (additional member) 3. The local pressure testing method S1 is performed on the intermediate flange 3 and the welded portion 4, and is not performed on the entirety of the casing 2. In the local pressure testing method S1, the through-hole 31 and the casing hole 21 are filled with water (liquid) while air is removed from the through-hole 31 and the casing hole 21, and are kept at a predetermined pressure for a certain period of time so as to confirm that the pressure is not lowered. As a result, in the local pressure testing method S1, water leakage from the inside of the intermediate flange 3 or the welded portion 4 and durability thereof are confirmed. The local pressure testing method S1 is performed using a local pressure testing jig 7.

### Local Pressure Testing Jig

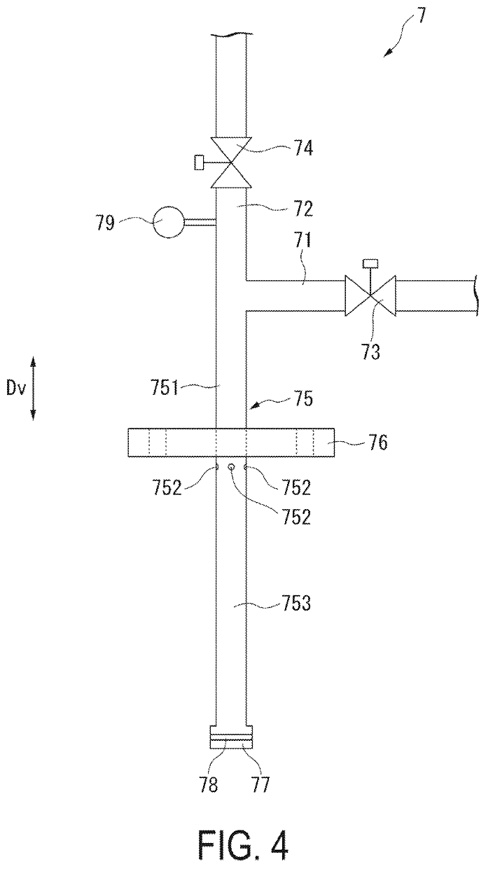

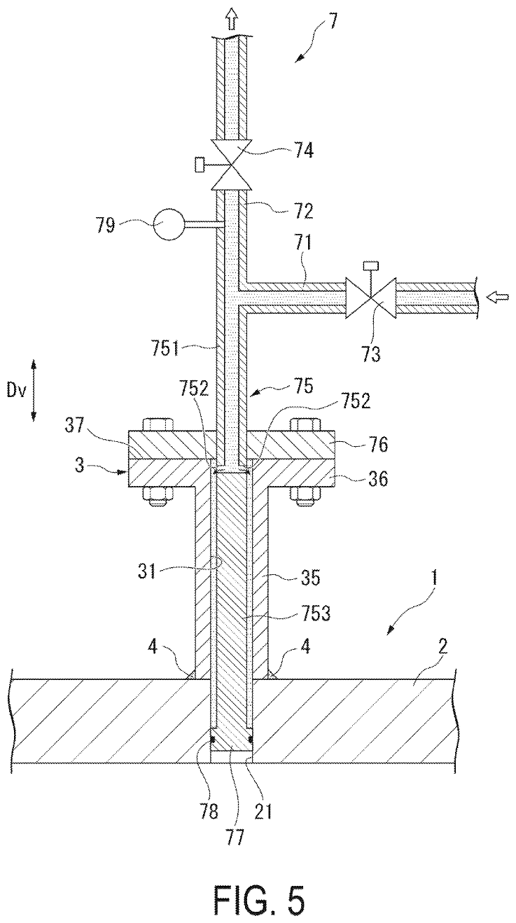

Here, the local pressure testing jig 7 will be described in detail. The local pressure testing jig 7 is used when a local pressure test is performed. The local pressure testing jig 7 can remove air from and supply water into the inside of the intermediate flange 3 in a state in which the intermediate flange 3 is sealed. As illustrated in FIG. 4 and FIG. 5, the local pressure testing jig 7 of the present embodiment includes a supply pipe 71, a discharge pipe 72, a supply valve 73, a discharge valve 74, an insertion pipe 75, a detachable retaining portion 76, a closing portion 77, a sealing portion 78, and a pressure measurement portion 79. In the local pressure testing jig 7, all members including the supply pipe 71, the discharge pipe 72, the supply valve 73, the discharge valve 74, the insertion pipe 75, the detachable retaining portion 76, the closing portion 77, the sealing portion 78, and the pressure measurement portion 79 are integrally formed and configured as one movable device.

The supply pipe 71 can supply water to the through-hole 31. The supply pipe 71 is a pipe connected to a pump (not illustrated). The supply pipe 71 is disposed outside the intermediate flange 3.

The discharge pipe 72 can discharge water from the through-hole 31. The discharge pipe 72 can discharge air from the through-hole 31. The discharge pipe 72 is a pipe connected to the outside of the local pressure testing jig 7 (the outside of the centrifugal compressor 1). The discharge pipe 72 is a pipe having the same diameter as the supply pipe 71. The discharge pipe 72 is disposed outside the intermediate flange 3.

The supply valve 73 can adjust the amount of water supplied from the supply pipe 71 to the through-hole 31. The supply valve 73 is disposed at the supply pipe 71. When the supply valve 73 is switched to an open state, the supply pipe 71 can supply water to the through-hole 31. When the supply valve 73 is switched to a closed state, the supply pipe 71 cannot supply water to the through-hole 31.

The discharge valve 74 can adjust the amount of water and air supplied from the through-hole 31 to the discharge pipe 72. The discharge valve 74 is disposed at the discharge pipe 72. When the discharge valve 74 is switched to an open state, the discharge pipe 72 can discharge water and air from the through-hole 31 to the outside. When the discharge valve 74 is switched to a closed state, the discharge pipe 72 cannot discharge water and air from the through-hole 31 to the outside.

The insertion pipe 75 is connected to the supply pipe 71 and the discharge pipe 72. The insertion pipe 75 can be inserted into the through-hole 31 and the casing hole 21. The insertion pipe 75 can be inserted into the intermediate flange 3 from above in the vertical direction Dv. The insertion pipe 75 is formed to have a smaller diameter than the through-hole 31. Specifically, the insertion pipe 75 is formed to have an outer diameter with which a gap can be formed between the insertion pipe 75 and the inside surfaces of the through-hole 31 and the casing hole 21 in a state in which the insertion pipe 75 is inserted in the inside surfaces of the through-hole 31 and the casing hole 21. The insertion pipe 75 of the present embodiment is formed integrally with the supply pipe 71 and the discharge pipe 72 into a T-shape. The insertion pipe 75 of the present embodiment includes a piping portion 751 and a solid portion 753.

The piping portion 751 is connected to the supply pipe 71 and the discharge pipe 72. The piping portion 751 of the present embodiment communicates with the insides of the supply pipe 71 and the discharge pipe 72. The piping portion 751 is a pipe having the same diameter as the supply pipe 71 and the discharge pipe 72. The lower end of the piping portion 751 is inserted into the through-hole 31. The upper end of the piping portion 751 is disposed outside the intermediate flange 3. That is, in a state in which the insertion pipe 75 is inserted in the through-hole 31 and the casing hole 21, only a lower partial region of the piping portion 751 is inserted in the through-hole 31.

A supply hole 752 is formed at the lower end of the piping portion 751. The supply hole 752 opens in the through-hole 31. The supply hole 752 can communicate with a space between the through-hole 31 and the insertion pipe 75. The supply hole 752 penetrates from the inside of the piping portion 751 to the outside surface of the piping portion 751. The supply hole 752 is formed in the vicinity of a boundary between the piping portion 751 and the solid portion 753. When the insertion pipe 75 is inserted into the through-hole 31, the supply hole 752 is disposed at a position close to an upper end surface 37 of the intermediate flange 3 facing upward in the vertical direction Dv with respect to the center of the through-hole 31 in the vertical direction Dv. When the insertion pipe 75 is inserted into the through-hole 31, the supply hole 752 is disposed below the upper end surface 37 of the intermediate flange 3 in the vertical direction Dv. A plurality of supply holes 752 are formed in the circumferential direction of the piping portion 751.

The solid portion 753 is connected to the piping portion 751 on the lower side in the vertical direction Dv. The solid portion 753 is connected to the piping portion 751 below the position where the supply holes 752 are formed in the vertical direction Dv. The solid portion 753 is formed in a solid cylindrical shape in which no space is formed. The solid portion 753 is formed integrally with the piping portion 751 to have the same outer diameter as the piping portion 751. The lower end of the solid portion 753 is inserted into the casing hole 21. The upper end of the solid portion 753 is disposed inside the through-hole 31. That is, in a state in which the insertion pipe 75 is inserted in the through-hole 31 and the casing hole 21, only a lower partial region of the solid portion 753 is inserted in the casing hole 21 and the other regions are disposed in the through-hole 31.

The detachable retaining portion 76 is detachably fixed to the intermediate flange 3 in a state in which the through-hole 31 is closed. The detachable retaining portion 76 can retain the insertion pipe 75 with respect to the intermediate flange 3. The detachable retaining portion 76 of the present embodiment protrudes outward in an annular shape from the outside surface of the piping portion 751. The detachable retaining portion 76 is disposed on the opposite side of the solid portion 753 with the supply holes 752 interposed therebetween. The detachable retaining portion 76 is fixed to the flange portion 36 by detachable bolts in a state of being in close contact with the upper end surface 37 of the flange portion 36. Accordingly, the detachable retaining portion 76 attaches the local pressure testing jig 7 to the intermediate flange 3 in a state in which the intermediate flange 3 is sealed.

The closing portion 77 closes the casing hole 21. The closing portion 77 is disposed at the leading end of the insertion pipe 75. The closing portion 77 is connected to the solid portion 753. The closing portion 77 is disposed on the opposite side of the detachable retaining portion 76 with the supply holes 752 interposed therebetween. The closing portion 77 can be inserted into the through-hole 31 and the casing hole 21. The closing portion 77 is formed to have substantially the same diameter as the casing hole 21. The closing portion 77 is formed to have a larger diameter than the insertion pipe 75. Specifically, the closing portion 77 is formed to have an outer diameter with which a gap cannot be formed between the closing portion 77 and the inside surface of the casing hole 21 in a state in which the closing portion 77 is inserted in the inside surface of the casing hole 21.

The sealing portion 78 seals between the closing portion 77 and the casing hole 21. The sealing portion 78 seals between the outside surface of the closing portion 77 and the inside surface of the casing hole 21. The sealing portion 78 is disposed at the closing portion 77. The sealing portion 78 is an O-ring or a combination of an O-ring and a backup ring, fixed to the outside surface of the closing portion 77.

The pressure measurement portion 79 can measure a pressure inside the supply pipe 71, the discharge pipe 72, or the insertion pipe 75. The pressure measurement portion 79 of the present embodiment is a pressure gauge attached to the discharge pipe 72. The pressure measurement portion 79 measures a pressure inside the through-hole 31 and the casing hole 21 by measuring a pressure inside the discharge pipe 72.

Detailed steps of the local pressure testing method S1 using the above-described local pressure testing jig 7 will be described. As illustrated in FIG. 3, in the local pressure testing method S1, first, the local pressure testing jig 7 is attached to the intermediate flange 3 (step S10). Specifically, in a state in which the insertion pipe 75 is inserted into the intermediate flange 3 fixed to the casing 2, the detachable retaining portion 76 is fixed to the intermediate flange 3. The detachable retaining portion 76 is fixed to the flange portion 36 by bolts in a state of being in close contact with the upper end surface 37 of the flange portion 36. Accordingly, the upper portion of the through-hole 31 is closed by the detachable retaining portion 76, and the lower portion of the casing hole 21 is closed by the closing portion 77 and the sealing portion 78. As a result, the through-hole 31 and the casing hole 21 are in a state of being sealed by the local pressure testing jig 7.

After the local pressure testing jig 7 is attached to the intermediate flange 3, the supply valve 73 and the discharge valve 74 are opened and water is supplied from the supply pipe 71 (step S20). Accordingly, the supply pipe 71 and the discharge pipe 72 are opened such that the water can flow therethrough. The water is supplied to the supply pipe 71 by driving a pump. The water supplied from the supply pipe 71 to the intermediate flange 3 accumulates in the through-hole 31 and the casing hole 21.

After the through-hole 31 is filled with the water, the discharge valve 74 is closed (step S30). Specifically, after the water is supplied from the supply pipe 71, the discharge pipe 72 is closed when the water is discharged from the discharge pipe 72 (step S31). When the water starts to be supplied from the supply pipe 71 and accumulates in the through-hole 31 and the casing hole 21, air originally staying inside the through-hole 31 and the casing hole 21 is pushed out by the water. As a result, the air inside the through-hole 31 and the casing hole 21 flows backward and passes through the supply hole 752 which keeps discharging the water, and is discharged from the discharge pipe 72 which is in the open state. Then, when the air inside the through-hole 31 and the casing hole 21 is eliminated and the through-hole 31 and the casing hole 21 are filled with the water, the water is discharged from the discharge pipe 72 in place of the air. In this state, the discharge valve 74 is closed to close the discharge pipe 72. That is, the water and the air can no longer flow through the discharge pipe 72.

After the discharge pipe 72 is closed, the supply of the water from the supply pipe 71 is stopped, and after a specified time determined in advance has elapsed, the supply of the water from the supply pipe 71 is resumed (step S32). Specifically, after the water is discharged from the discharge pipe 72, the discharge valve 74 is closed to close the discharge pipe 72, and the pump is stopped. Accordingly, the supply of water from the supply pipe 71 is interrupted. After the specified time of about several minutes has elapsed, the pump is driven to resume the supply of the water. While waiting for the specified time of several minutes, whether the through-hole 31 and the casing hole 21, which are sealed pressurized spaces, are completely filled with the water may be monitored by checking a change in pressure by the pressure measurement portion 79.

Then, after the discharge valve 74 is closed, whether the pressure measured by the pressure measurement portion 79 has exceeded a predetermined test pressure is determined (step S40). Specifically, after the discharge valve 74 is closed and the supply of the water from the supply pipe 71 is resumed, whether the pressure measured by the pressure measurement portion 79 has reached the test pressure is determined. The test pressure is, for example, a value larger than a pressure value applied to the intermediate flange 3 during operation of the rotary machine. The test pressure is, for example, a value of about 1.5 to 2.0 times a pressure value applied to the intermediate flange 3 during operation of the centrifugal compressor 1.

When it is determined that the pressure measured by the pressure measurement portion 79 has exceeded the test pressure, the supply valve 73 is closed (step S50). Specifically, the supply valve 73 is closed and the supply pipe 71 is closed. Thus, the water can no longer flow through the supply pipe 71. Also, the pump is stopped.

After the supply valve 73 is closed, a hydraulic test is performed on the welded portion 4 (step S60). Specifically, the intermediate flange 3 is subjected to the hydraulic test in which elapse of a predetermined period of time or a pressure change such as pressurization or depressurization is required.

After the hydraulic test is performed, the supply valve 73 and the discharge valve 74 are opened (step S70). As a result, the supply pipe 71 and the discharge pipe 72 are opened, and the pressure in the through-hole 31 and the casing hole 21 is released. Then, the detachable retaining portion 76 is detached from the intermediate flange 3, and the local pressure testing jig 7 is detached.

### Operational Effects

In the local pressure testing jig 7 and the local pressure testing method S1, the upper portion of the through-hole 31 is closed by the detachable retaining portion 76, and the lower portion of the casing hole 21 is closed by the closing portion 77 and the sealing portion 78. As a result, the through-hole 31 and the casing hole 21 are brought into a sealed state of being sealed by the local pressure testing jig 7. Water is supplied from the supply pipe 71 to the through-hole 31 and the casing hole 21 in the sealed state, and internal air is discharged from the discharge pipe 72. Accordingly, the through-hole 31 and the casing hole 21 which are sealed are filled with the water, and the hydraulic test can be performed. That is, the hydraulic test can be performed on the intermediate flange 3 and the welded portion 4 without supplying the water to the entire region inside the casing 2. Thus, a local pressure test can be performed only on the intermediate flange 3 without covering the entire region of the centrifugal compressor 1 including the intermediate flange 3. Therefore, the test can be completed at a site in which the centrifugal compressor 1 is already installed without sending the centrifugal compressor 1 including the casing 2 to a facility such as a factory where a large-scale test can be performed. In this way, the pressure test can be efficiently performed on the welded portion 4 between the additional member and the casing 2.

The supply hole 752 is disposed at a position close to the upper end surface 37 of the intermediate flange 3 when the insertion pipe 75 is inserted into the through-hole 31. Thus, water is supplied into the through-hole 31 and the casing hole 21 from above. Then, air originally staying inside the through-hole 31 and the casing hole 21 is pushed out by the water and rises upward in the vertical direction Dv. As a result, the air inside the through-hole 31 and the casing hole 21 reaches the supply hole 752 and is discharged from the discharge pipe 72 via the supply hole 752. In this way, even when the water is continuously supplied from the supply hole 752, the air inside the through-hole 31 and the casing hole 21 can be discharged from the supply hole 752 with high accuracy. Accordingly, it is possible to efficiently discharge the air inside the through-hole 31 and the casing hole 21 and fill the through-hole 31 and the casing hole 21 with the water. As a result, the supply of the water and the discharge of the air are efficiently performed, and the hydraulic test can be quickly performed.

The sealing portion 78 is an O-ring or a combination of an O-ring and a backup ring, fixed to the outside surface of the closing portion 77. Thus, the casing hole 21 can be airtightly closed by a simple operation of only inserting the closing portion 77 into the casing hole 21.

The detachable retaining portion 76 is attachable to and detachable from the flange portion 36 in a state of being in close contact with the upper end surface 37 of the intermediate flange 3 facing upward in the vertical direction Dv. Thus, the upper portion of the through-hole 31 can be airtightly closed by a simple operation of only fixing the detachable retaining portion 76 to the flange portion 36.

In closing the discharge valve 74 after the through-hole 31 is filled with the water, the supply of the water from the supply pipe 71 is stopped after the discharge pipe 72 is closed. Then, the supply of the water from the supply pipe 71 is resumed after a lapse of a specified time. Accordingly, the supply of the water is stopped, and thus the flow of the water in the through-hole 31 and the casing hole 21 is stopped. As a result, a small amount of air remaining in the through-hole 31 while the water is continuously supplied gradually rises in the water accumulated in the through-hole 31 and is discharged. Thus, the air remaining in the through-hole 31 can be discharged with high accuracy.

### Other Embodiments

Although the embodiment of the present disclosure has been described in detail with reference to the accompanying drawings, specific configurations are not limited to the embodiment, and include design changes and the like without departing from the gist of the present disclosure.

Note that the rotary machine is not limited to the centrifugal compressor 1 of the present embodiment. The rotary machine may be an axial compressor, a turbine, a pump, or a motor as long as an additional member having a tubular shape can be fixed thereto.

The liquid used for the local pressure testing jig 7 and the local pressure testing method S1 is not limited to water. For example, a solution suitable for the material of the additional member to be tested may be used as the liquid.

Each of the supply valve 73 and the discharge valve 74 may be an on-off valve capable of adjusting the supply state of water in either a fully-opened state or a fully-closed state, or may be a flow control valve capable of supplying water at an arbitrary flow rate by adjusting the opening degree. In addition, each of the supply valve 73 and the discharge valve 74 may be a solenoid valve that can be automatically opened and closed, or may be a valve device that is manually opened and closed.

The insertion pipe 75 is not limited to having a structure including the solid portion 753 as a part of the insertion pipe 75. The insertion pipe 75 may be formed as the piping portion 751 as a whole, as long as the insertion pipe 75 is strong enough not to be deformed by the pressure of the liquid in the through-hole 31.

The pressure measurement portion 79 is not limited to being attached to the discharge pipe 72 as in the present embodiment. The pressure measurement portion 79 is only required to be capable of measuring a pressure inside the supply pipe 71, the discharge pipe 72, or the insertion pipe 75. Thus, the pressure measurement portion 79 may be disposed at the supply pipe 71 or the insertion pipe 75. Supplementary Notes

The local pressure testing jig 7 and the local pressure testing method S1 described in the embodiments are understood as follows, for example.

(1) A local pressure testing jig 7 according to a first aspect is a local pressure testing jig 7 used for performing a local pressure test on a welded portion 4 of a casing 2 of a rotary machine, the local pressure test being performed by supplying liquid to an additional member having a tubular shape that is fixed to the casing 2 by the welded portion 4 in a state in which a through-hole 31 inside the additional member and a casing hole 21 formed in the casing 2 communicate with each other. The local pressure testing jig 7 includes: a supply pipe 71 capable of supplying the liquid to the through-hole 31; a discharge pipe 72 capable of discharging the liquid from the through-hole 31; a supply valve 73 disposed at the supply pipe 71, the supply valve 73 being capable of adjusting a supply amount of the liquid from the supply pipe 71 to the through-hole 31; a discharge valve 74 disposed at the discharge pipe 72, the discharge valve 74 being capable of adjusting a discharge amount of the liquid from the through-hole 31 to the discharge pipe 72; an insertion pipe 75 connected to the supply pipe 71 and the discharge pipe 72, the insertion pipe 75 being capable of being inserted into the through-hole 31 and the casing hole 21; a detachable retaining portion 76 detachably fixed to the additional member in a state in which the through-hole 31 is closed, the detachable retaining portion 76 being capable of retaining the insertion pipe 75 with respect to the additional member; a closing portion 77 disposed at a leading end of the insertion pipe 75, the closing portion 77 closing the casing hole 21; a sealing portion 78 disposed at the closing portion 77, the sealing portion 78 sealing between the closing portion 77 and the casing hole 21; and a pressure measurement portion 79 capable of measuring a pressure inside the supply pipe 71, the discharge pipe 72, or the insertion pipe 75. The insertion pipe 75 is formed to have a smaller diameter than the through-hole 31, and includes a supply hole 752, opening in the through-hole 31 and capable of communicating with a space between the through-hole 31 and the insertion pipe 75.

With this configuration, the upper portion of the through-hole 31 is closed by the detachable retaining portion 76, and the lower portion of the casing hole 21 is closed by the closing portion 77 and the sealing portion 78. As a result, the through-hole 31 and the casing hole 21 are brought into a sealed state of being sealed by the local pressure testing jig 7. The liquid is supplied from the supply pipe 71 to the through-hole 31 and the casing hole 21 in the sealed state, and inside air is discharged from the discharge pipe 72. Accordingly, the through-hole 31 and the casing hole 21 which are sealed are filled with the liquid, and the hydraulic test can be performed. That is, the hydraulic test can be performed on the additional member and the welded portion 4 without supplying the liquid to the entire region inside the casing 2. Thus, a local pressure test can be performed only on the additional member without covering the entire region of the centrifugal compressor 1 including the additional member. Therefore, the test can be completed at a site in which the centrifugal compressor 1 is already installed without sending the centrifugal compressor 1 including the casing 2 to a facility such as a factory where a large-scale test can be performed. In this way, the pressure test can be efficiently performed on the welded portion 4 between the additional member and the casing 2.

(2) A local pressure testing jig 7 according to a second aspect is the local pressure testing jig 7 of (1), wherein when the insertion pipe 75 is inserted into the through-hole 31, the supply hole 752 is disposed at a position close to an upper end surface 37 of the additional member with respect to a center of the through-hole 31 in the vertical direction Dv, the upper end surface 37 facing upward in a vertical direction Dv.

With this configuration, the liquid is supplied into the through-hole 31 and the casing hole 21 from above. Then, air originally staying inside the through-hole 31 and the casing hole 21 is pushed out by the liquid and rises upward in the vertical direction Dv. As a result, the air inside the through-hole 31 and the casing hole 21 reaches the supply hole 752 and is discharged from the discharge pipe 72 via the supply hole 752. In this way, even when the liquid is continuously supplied from the supply hole 752, the air inside the through-hole 31 and the casing hole 21 can be discharged from the supply hole 752 with high accuracy. Accordingly, it is possible to efficiently discharge the air inside the through-hole 31 and the casing hole 21 and fill the through-hole 31 and the casing hole 21 with the liquid. As a result, the supply of the liquid and the discharge of the air are efficiently performed, and the hydraulic test can be quickly performed.

(3) A local pressure testing jig 7 according to a third aspect is the local pressure testing jig 7 of (1) or (2), wherein the sealing portion 78 is an O-ring or a combination of an O-ring and a backup ring, fixed to an outside surface of the closing portion 77.

With this configuration, the casing hole 21 can be airtightly closed by a simple operation of only inserting the closing portion 77 into the casing hole 21.

(4) A local pressure testing jig 7 according to a fourth aspect is the local pressure testing jig 7 of any one of (1) to (3), wherein the detachable retaining portion 76 is attachable to and detachable from the additional member in a state of being in close contact with an upper end surface 37 of the additional member, the upper end surface 37 facing upward in the vertical direction Dv.

With this configuration, the upper portion of the through-hole 31 can be airtightly closed by a simple operation of only fixing the detachable retaining portion 76 to the additional member.

(5) A local pressure testing method S1 according to a fifth aspect is a local pressure testing method S1 using the local pressure testing jig 7 of any one of (1) to (4) and includes: attaching the local pressure testing jig 7 to the additional member by fixing the detachable retaining portion 76 to the additional member; supplying the liquid from the supply pipe 71 by opening the supply valve 73 and the discharge valve 74; closing the discharge valve 74 after the through-hole 31 is filled with the liquid; determining whether a pressure measured by the pressure measurement portion 79 exceeds a test pressure determined in advance after the discharge valve 74 is closed; closing the supply valve 73 when it is determined that the pressure measured by the pressure measurement portion 79 exceeds the test pressure; performing a hydraulic test on the welded portion 4 after the supply valve 73 is closed; and opening the supply valve 73 and the discharge valve 74 after the hydraulic test is performed.

With this configuration, the upper portion of the through-hole 31 is closed by the detachable retaining portion 76, and the lower portion of the casing hole 21 is closed by the closing portion 77 and the sealing portion 78. As a result, the through-hole 31 and the casing hole 21 are brought into a sealed state of being sealed by the local pressure testing jig 7. The liquid is supplied from the supply pipe 71 to the through-hole 31 and the casing hole 21 in the sealed state, and inside air is discharged from the discharge pipe 72. Accordingly, the through-hole 31 and the casing hole 21 which are sealed are filled with the liquid, and the hydraulic test can be performed. That is, the hydraulic test can be performed on the additional member and the welded portion 4 without supplying the liquid to the entire region inside the casing 2. Thus, a local pressure test can be performed only on the additional member without covering the entire region of the centrifugal compressor 1 including the additional member. Therefore, the test can be completed at a site in which the centrifugal compressor 1 is already installed without sending the centrifugal compressor 1 including the casing 2 to a facility such as a factory where a large-scale test can be performed. In this way, the pressure test can be efficiently performed on the welded portion 4 between the additional member and the casing 2.

(6) A local pressure testing method S1 according to a sixth aspect is the local pressure testing method S1 of any one of (1) to (5), wherein the closing the discharge valve 74 includes: closing the discharge pipe 72 when the liquid is discharged from the discharge pipe 72 after the liquid is supplied from the supply pipe 71; and stopping supply of the liquid from the supply pipe 71 after the discharge pipe 72 is closed, and after a lapse of a specified time determined in advance, resuming the supply of the liquid from the supply pipe 71.

With this configuration, since the supply of the liquid is stopped, the flow of the liquid in the through-hole 31 and the casing hole 21 is stopped. As a result, a small amount of air remaining in the through-hole 31 while the liquid is continuously supplied gradually rises in the liquid accumulated in the through-hole 31 and is discharged. Thus, the air remaining in the through-hole 31 can be discharged with high accuracy.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A local pressure testing jig used for performing a local pressure test on a welded portion of a casing of a rotary machine, the local pressure test being performed by supplying liquid to an additional member having a tubular shape that is fixed to the casing by the welded portion in a state in which a through-hole inside the additional member and a casing hole formed in the casing communicate with each other, the local pressure testing jig comprising:
a supply pipe configured to supply the liquid to the through-hole;
a discharge pipe configured to discharge the liquid from the through-hole;
a supply valve disposed at the supply pipe and configured to adjust a supply amount of the liquid from the supply pipe to the through-hole;
a discharge valve disposed at the discharge pipe and configured to adjust a discharge amount of the liquid from the through-hole to the discharge pipe;
an insertion pipe connected to the supply pipe and the discharge pipe and configured to be inserted into the through-hole and the casing hole;
a detachable retaining portion detachably fixed to the additional member in a state in which the through-hole is closed, and configured to retain the insertion pipe with respect to the additional member;
a closing portion disposed at a leading end of the insertion pipe and configured to close the casing hole;
a sealing portion disposed at the closing portion and configured to seal between the closing portion and the casing hole; and
a pressure measurement portion configured to measure a pressure inside the supply pipe, the discharge pipe, or the insertion pipe,
the insertion pipe being formed to have a smaller diameter than the through-hole, and including a supply hole opening in the through-hole and being configured to communicate with a space between the through-hole and the insertion pipe.

2. The local pressure testing jig according to claim 1, wherein
when the insertion pipe is inserted into the through-hole, the supply hole is disposed at a position close to an upper end surface of the additional member with respect to a center of the through-hole in a vertical direction, the upper end surface facing upward in the vertical direction.

3. The local pressure testing jig according to claim 1, wherein
the sealing portion is an O-ring or a combination of an O-ring and a backup ring, fixed to an outside surface of the closing portion.

4. The local pressure testing jig according to claim 1, wherein
the detachable retaining portion is attachable to and detachable from the additional member in a state of being in close contact with an upper end surface of the additional member, the upper end surface facing upward in a vertical direction.

5. A local pressure testing method using the local pressure testing jig according to claim 1, the local pressure testing method comprising:
attaching the local pressure testing jig to the additional member by fixing the detachable retaining portion to the additional member;
supplying the liquid from the supply pipe by opening the supply valve and the discharge valve;
closing the discharge valve after the through-hole is filled with the liquid;
determining whether a pressure measured by the pressure measurement portion exceeds a test pressure determined in advance, after the discharge valve is closed;
closing the supply valve when it is determined that the pressure measured by the pressure measurement portion exceeds the test pressure;
performing a hydraulic test on the welded portion after the supply valve is closed; and
opening the supply valve and the discharge valve after the hydraulic test is performed.

6. The local pressure testing method according to claim 5, wherein
the closing the discharge valve includes
closing the discharge pipe when the liquid is discharged from the discharge pipe after the liquid is supplied from the supply pipe; and
stopping supply of the liquid from the supply pipe after the discharge pipe is closed, and after a lapse of a specified time determined in advance, resuming the supply of the liquid from the supply pipe.
